(19) United States
(12) Patent Application Publication
(10) Pub. No.: US 2011/0296003 A1
(43) Pub. Date: Dec. 1, 2011

(54) USER ACCOUNT BEHAVIOR TECHNIQUES

(75) Inventors: Robert L. McCann, Fall City, WA (US); Eliot C. Gillum, Mountain View, CA (US); Krishna Vitaldevara, Fremont, CA (US); Jason D. Walter, San Jose, CA (US); Linda A. McColm, Los Gatos, CA (US); Ivan Osipkov, Bellevue, WA (US)

(73) Assignee: MICROSOFT CORPORATION, Redmond, WA (US)

(21) Appl. No.: 12/791,777

(22) Filed: Jun. 1, 2010

(51) Int. Cl. G06F 15/16

(52) U.S. Cl. 709/224

(57) ABSTRACT

User account behavior techniques are described. In implementations, a determination is made as to whether interaction with a service provider via a user account deviates from a model. The model is based on behavior that was previously observed as corresponding to the user account. Responsive to a determination that the interaction deviates from the model, the user account is flagged as being potentially compromised by a malicious party.

### BACKGROUND

The compromise of user accounts by malicious parties is an increasingly significant problem faced by service providers, e.g., web services. Once the user account is compromised, the malicious party may have access to the data/privileges in the account as well as the key to other user accounts that may be accessible using the same information, e.g., login, passwords, email address, and so on.

The user account may be compromised in a variety of ways. For example, passwords may be stolen using malicious software on a client device that is used to login to the service, through a phishing request for a user to submit credentials under false pretense, through a “man in the middle” attack where a cookie or session is stolen, through brute force attacks, through social engineering attacks, and so on.

Once the user account is compromised, the account may be used for a variety of malicious purposes, such as to send additional phishing or spam messages to other users on a contact list. Because of the inherent trust that contacts have for email from a friend, the response rates to campaigns using stolen email accounts to send messages are generally superior to traditional campaigns, which may therefore further exacerbate the problem caused by a compromised user account. The user account may also be used for broader spamming, since this allows the malicious party to counter abuse detection technology, at least for awhile.

Further, information gained from accessing the account may be leveraged. For instance, a malicious party may use the information to access other user accounts, such as for financial services, merchant sites, and more. In another instance, the information may describe other email addresses. In either instance, this information may be sold to other malicious parties. Thus, account compromise may pose a significant problem to the web service as well as a user of the web service.

### SUMMARY

User account behavior techniques are described. In implementations, a determination is made as to whether interaction with a service provider via a user account deviates from a model. The model is based on behavior that was previously observed as corresponding to the user account. Responsive to a determination that the interaction deviates from the model, the user account is flagged as being potentially compromised by a malicious party.

In implementations, a model is generated that describes behavior exhibited through interaction via a user account of a service provider, the interaction performed over a network. Responsive to a determination that subsequent interaction performed via the user account deviates from the generated model, the user account is flagged as potentially compromised by a malicious party.

In implementations, data is examined that describes interaction with a service provider via a user account. Two or more distinct behavioral models are detected through the examination that indicates different personalities, respectively, in relation to the interaction with the service provider. Responsive to the detection, the user account is flagged as being potentially compromised by a malicious party.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ user account behavior techniques.

FIG. 2 is an illustration of a system in an example implementation showing a behavior module of FIG. 1 in greater detail.

FIG. 3 is an illustration of an example user interface that is configured in accordance with one or more behavior techniques.

FIG. 4 is a flow diagram depicting a procedure in an example implementation in which a model is generated that describes user behavior that is leveraged to detect whether a user account is compromised.

FIG. 5 is a flow diagram depicting a procedure in an example implementation in which detection of different personalities having distinct behaviors is employed to detect compromise of a user account.

### DETAILED DESCRIPTION

Overview

Compromise of user accounts by malicious parties may be harmful both to a service provider (e.g., a web service) that provides the account as well as to a user that is associated with the account. Traditional techniques that were developed to detect and mitigate against these attacks, however, relied on identification of malicious actions. Therefore, these traditional techniques might miss identifying a user account that was compromised if a malicious action was not performed in conjunction with the compromise, e.g., such as to steal information but not send spam.

User account behavior techniques are described. In implementations, behavior associated with a user account is modeled, e.g., through the use of statistics that describe typical user behavior associated with the user account. The model is then used to monitor subsequent user behavior in relation to the account. Deviations of the subsequent user behavior from the model may then be used as a basis to determine as to whether the user account is likely compromised by a malicious party. In this way, the compromise of the user account by a malicious party may be detected without reliance upon performance of a malicious action by the party, further discussion of which may be found in relation to the following sections.

In the following discussion, an example environment is first described that is operable to perform user account behavior technqiues. Example procedures are then described, which may be employed in the example environment as well as in other environments, and vice versa. Accordingly, performance of the example procedures is not limited to the example environment and the example environment is not limited to performance of the example procedures.

Example Environment

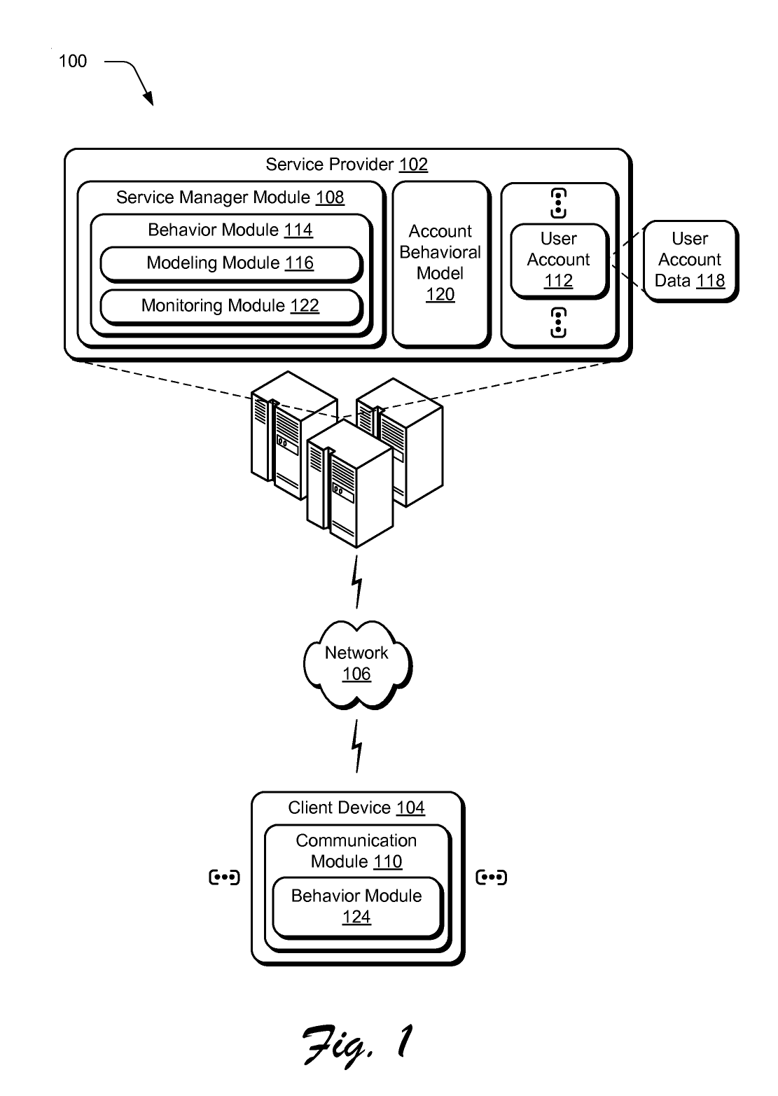

FIG. 1 is an illustration of an environment 100 in an example implementation that is operable to employ user account behavior techniques. The illustrated environment 100 includes a service provider 102 and a client device 104 that are communicatively coupled over a network 108. The client device 104 may be configured in a variety of ways. For example, the client device 104 may be configured as a computing system that is capable of communicating over the network 106, such as a desktop computer, a mobile station, an entertainment appliance, a set-top box communicatively coupled to a display device, a wireless phone, a game console, and so forth. Thus, the client device 104 may range from full resource devices with substantial memory and processor resources (e.g., personal computers, game consoles) to a low-resource device with limited memory and/or processing resources (e.g., traditional set-top boxes, hand-held game consoles).

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks.

The service provider 102 is illustrated as including a service manager module 108 that is representative of functionality to provide a service that is accessible via the network, e.g., a web service. For example, the service manager module 108 may be configured to provide an email service, a social networking service, an instant messaging service, an online storage service, and so on. The client device 104 may access the service provider 102 using a communication module 110, which is representative of functionality of the client device 104 to communicate via the network 106. For example, the communication module 110 may be representative of browser functionality of the client device 104, functionality to access one or more application programming interfaces (APIs) of the service manager module 108, and so on.

To interact with the service provider 102, the client device 104 (and more particular a user of the client device) may access a user account 112 maintained by the service manager module 108. For example, the user account 112 may be accessed with one or more login credentials, e.g., a user name and password. After verification of the credentials, a user of the client device 104 may interact with services provided by the service manager module 108. However, as previously described the user account 112 may be compromised by a malicious party, such as by determining which login credentials were used to access the service provider 102.

The service manager module 108 is also illustrated as including a behavior module 114 that is representative of functionality involving user account behavior techniques. The techniques employed by the behavior module 114 may be used to detect whether the user account 112 has been compromised, and may even do so with detecting a “malicious action.”

For example, the behavior module 114 is further illustrated as including a modeling module 116 that is representative of functionality to examine user account data 118 associated with a user account 112 to generate an account behavioral model 120, hereinafter simply referred to as “model 120.” The model 120 describes observed interaction with the service provider 102 that has been performed via the user account 112. Thus, the account behavioral model 120 may serve as a baseline to describe typical interaction performed in conjunction with the user account 112.

The model 120 may then be used by the monitoring module 122 to determine when user interaction performed via the user account 112 deviates from the model 120. This deviation may therefore indicate that the user account 112 may have been compromised. For example, the model 120 may describe login times of a user. Logins times that are not consistent with the model 120 may serve as a basis for determining that the account has been compromised. Actions may then be taken by the behavior module 114, such as to restrict functionality that may be used for malicious purposes, block access to the user account 112 altogether, and so on. A variety of different characteristics of user interaction with the user account 112 may be described by the user account data 118 and service as a basis for the model 120, further discussion of which may be found in relation to the following figure. Although the environment has been discussed as employing the functionality of the behavior module 114 by the service provider 102, this functionality may be implemented in a variety of different ways, such as at a “stand-alone” service that is apart from the service provider 102, by the client device 104 itself as represented by the behavior module 124, and so on.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices, such as a digital video disc (DVD), compact disc (CD), flash drive, hard drive, and so on. The features of the user account behavior techniques described below are platform-independent, meaning that the techniques may be implemented on a variety of commercial computing platforms having a variety of processors.

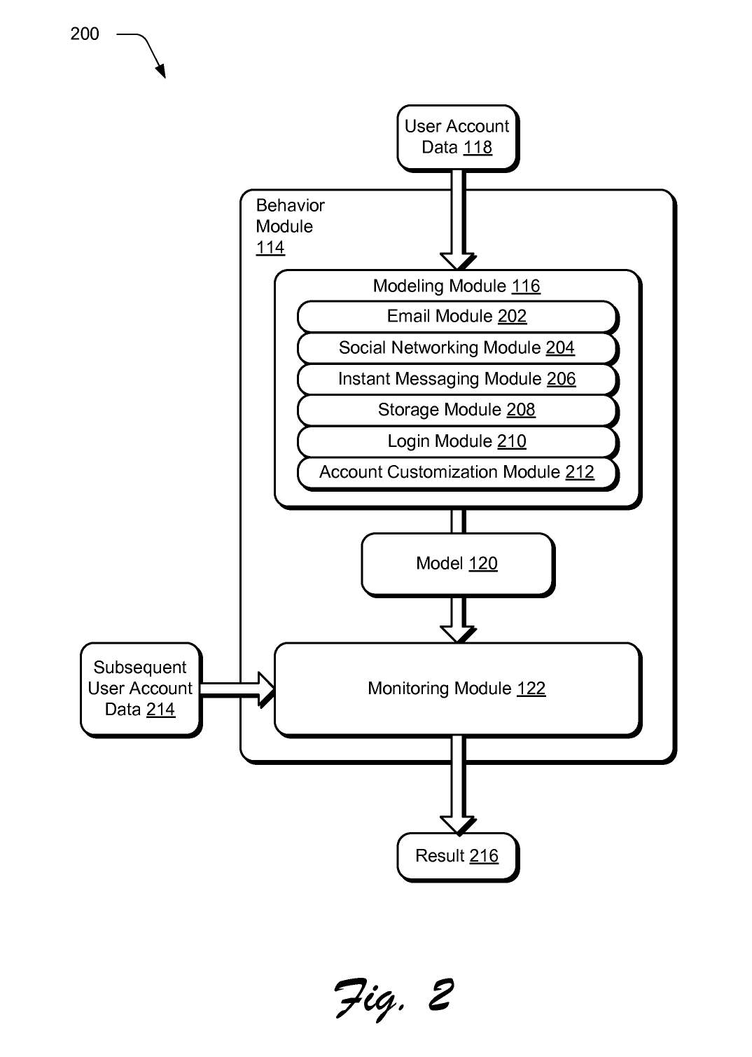

FIG. 2 is an illustration of a system in an example implementation showing a behavior module 114 of FIG. 1 in greater detail. As described above, the behavior module 114 may be configured to compute statistics on a user's typical behavior with respect to the user account 112, and then flag the account 122 as possibly compromised if this behavior suddenly changes. For example, if a consistent email user suddenly logs in at a “strange” time (i.e., a time at which the user has not previously logged in) and sends email to people that the user has never send to, there is a reasonable chance that the account has been hijacked.

By detecting changes in the behavior associated with the user account 112, change detection may be harder to “game” by a malicious party. In order to beat a good versus bad behavior model, a malicious party may avoid obviously bad behavior (e.g., sending spam) and thus “fly under the radar.” In order to defeat the user account behavior techniques described herein, however, the malicious party attempts to mimic each individual user's typical behavior. Therefore, it is not simply enough to act “reasonably” in the global sense.

A variety of different behaviors may be modeled by the modeling module 116 of the behavior module 114, examples of which are illustrated as corresponding to different modules of the modeling module 116 and are discussed as follows.

Email Module 202

The email module 202 is representative of functionality regarding the modeling of behaviors related to email. As previously described, the user account behavior techniques are not limited to detection of good versus bad behavior, but may also capture the habits of a particular user. Examples of email-related statistics that may be captured by the account behavior module 120 may include how often a user typically sends/reads/folders/deletes/replies-to email. In another example, the email module 202 may model the how “tidy” the user keeps their account (e.g., does the user leave email in the inbox, frequently clean out a sent/junk folders, and so on).

The email module 202 may also model a sequence in which actions are performed during a given session, e.g., triage then read email. The email module 202 may also model a variety of other characteristics. For example, the email module 202 may monitor who sent an email and actions taken with respect to the email, which contacts co-occur in emails, what type of content is sent (e.g., does the user send plain text, rich text, or HTML), what URLs are included in the emails, what scores does an email filter give to those mails, and so on. A variety of other examples are also contemplated.

Social Networking Module 204

Another way to model user behavior is to describe how the user interacts with social networks. Accordingly, the social network module 204 may model how often a user sends friend invitations, leaves comments on other user's sites, how often the user changes their content (e.g., changes a profile picture). The social network module 204 may also model the content sent via the service (e.g., what kind, how much, and how often), length of comments (e.g., the user typically adds verbose plain text posts but suddenly leaves a short link), what domains are frequented, and so forth.

Instant Messaging Module 206

Another facet involves instant messaging. Accordingly, the instant messaging module 206 may employ techniques to model instant messaging use, including whether informal spellings are typically used (and if so, what?), users that typically interact via chat, does the chat typically involve video, phone, or a computer, and so on. Additionally, it should be noted that many of the email and social networking technqiues described above may also apply here as well as elsewhere.

Online Storage Module 208

The storage module 208 may be configured to model how a user employs online data storage. For example, the storage module 208 may model how much data is typically stored, what file types, correlation between a “date modified” metadata of the file and when it was uploaded, how often the data and/or directory structure is changed, with whom data is shared, and so on.

Login Module 210

The login module 210 is configured to model characteristics that pertain to login to the service provider 102. For example, the login module 210 may model whether the user account 116 is used to access multiple services of the service provider 102, at what times and how often does the user login, from where does the user login (e.g., IP address), how long does the session typically last, a particular order at which services of the service provider 102 are accessed, and so on.

Account Customization Module 212

Another set of behaviors that may span several services of the service provider 102 is the level of user customization applied to the user account 116. Accordingly, the account customization module 212 may model whether the user typically uses default settings for each service, how often does the user customize the account, what security setting is employed, frequency of contact with new users, and so on.

Although specific examples are shown, a variety of different user account data 118 may be employed to generate the model 120. For example, behaviors that are typically consistent for a given user, but vary significantly across different users, are good candidates to be used as a basis to generate the model 120. The model 120 may then be used by the monitoring module 122 to detect a change in behavior using subsequent user account data 214. In this way, the behavior module 114 may determine whether the user's behavior as changed and output a result 216 of this determination, further discussion of which may be found in relation to the following figure.

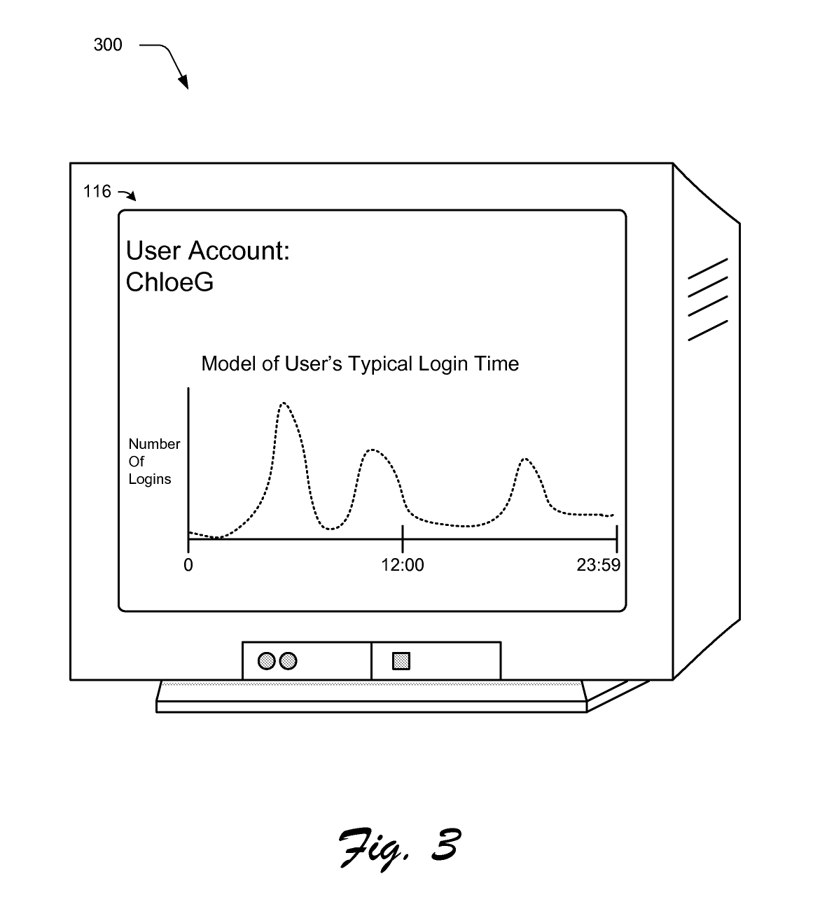

FIG. 3 depicts an example user interface 300 that models logins observed for a user account. In this example, the logins are modeled for different times of the day for a user “ChloeG.” Thus, this example models a user's behavior as a rolling summary of each type of statistic for a window of time, e.g., the past 30 days. This model may then be used as a basis to detect a change in behavior, such as when a user logs in at a time that is not typically observed.

Given these summaries of recent user behavior, the behavior module 114 may then determine when the behavior deviates from the model. One such scheme that may be employed is as follows. For a given user U, and on some schedule (e.g., each time a new statistic is received for the user, each time the user logs in, and so on, the behavior module 114 may determine if the user's account was recently hijacked by performing the following procedure.

For a statistic sᵢ (e.g., a most recent login time from U's account), associated model Mᵢ^{U} for that account (e.g., U's current login-time distribution), and global model Mᵢ^{G} for this statistic (e.g., distribution of recent login times over all users), the amount of “evidence” wᵢ, is computed that this particular observation gives to the case that the most recent behavior came from a user other than U using the following expression.

$${w}_{i} = log ( \frac{Pr [ {s}_{i} \vert {M}_{i}^{G} ]}{Pr [ {s}_{i} \vert {M}_{i}^{U} ]} )$$

If the most recent login time from U's account suggests that it was in fact U logging in (e.g., because U logs in at a regular time each day, which is also not an overly common time for other users), then wᵢ will result in a relatively large negative number. If this behavior strongly suggests that it U was not logging in, though, then wᵢ will result in a relatively large positive number. If the behavior is not generally informative (e.g., because U doesn't have a regular login time and/or many other users have similar login profiles to U), then wᵢ will be close to 0.

These pieces of evidence may then be combined to compute a score S^{U}, that is indicative of overall belief that some user other than U has been using U's account.

$${S}^{U} = {\sum }_{\{ \begin{matrix}i i n top \\ 25 \% of \vert {W}_{i} \vert\end{matrix} \}} {w}_{i}$$

This scheme sums pieces of evidence to reach a final score. Evidence that provides a strong indication that somebody else is using U's account will produce a large value for S^{U}. If the score is sufficiently convincing that the account is compromised (e.g., S^{U}≧θ), appropriate action may be taken. Examples of such actions include limiting services temporarily, charging an increased human interactive proof cost for use of services from the service provider 102, quarantining the user account, decreasing a reputation of the user account 116, notifying a user associated with the account, and so on.

Example Procedures

The following discussion describes user account behavior techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1, the system 200 of FIG. 2, and the user interface 300 of FIG. 3.

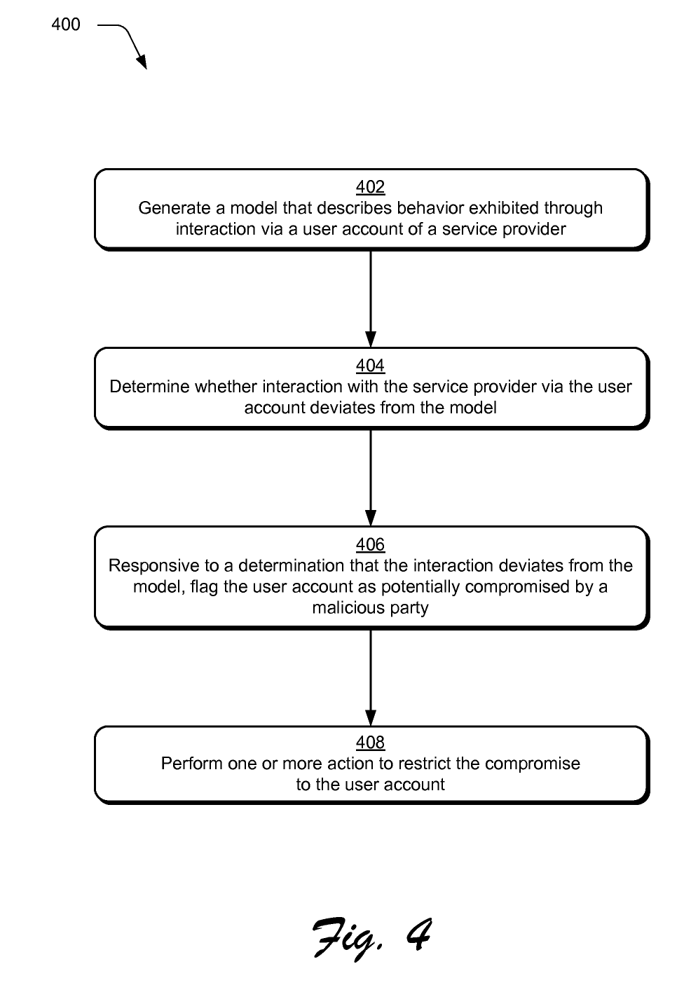

FIG. 4 depicts a procedure 400 in an example implementation in which a model is generated that describes user behavior that is leveraged to detect whether a user account is compromised. A model is generated that describes behavior exhibited through interaction via a user account of a service provider (block 402). For example, the service provider may be configured to provide a variety of different services, such as email, instant messaging, text messaging, online storage, social networking, and so on. The user's interaction with these services may serve as a basis to generate a model that describes a “baseline” and/or “typical” behavior of the user with the services.

A determination is then made as to whether interaction with the service provider via the user account deviates from the model (block 404). For example, the behavior module 114 may examine subsequent user account data 214 that describes subsequent interaction with the service provider 102. This subsequent interaction may be “scored” as previously described.

Responsive to a determination that the interaction deviates from the model, the user account is flagged as potentially compromised by a malicious party (block 406). Continuing with the previous example, the score may be compared with a threshold that is indicative of whether the user account is likely compromised or not. If so, the user account may be flagged by the behavior module.

One or more actions may then be performed to restrict the compromise to the user account (block 408). For example, the behavior module may permit actions that are consistent with the behavior module but restrict actions that are not, quarantine the user account, and so on. A variety of other examples are also contemplated. Although in the previous discussion the behavior module was described as being used to identify subsequent compromise, these technqiues may also be employed to detect whether the user account has already been compromised, further discussion of which may be found in relation to the following figure.

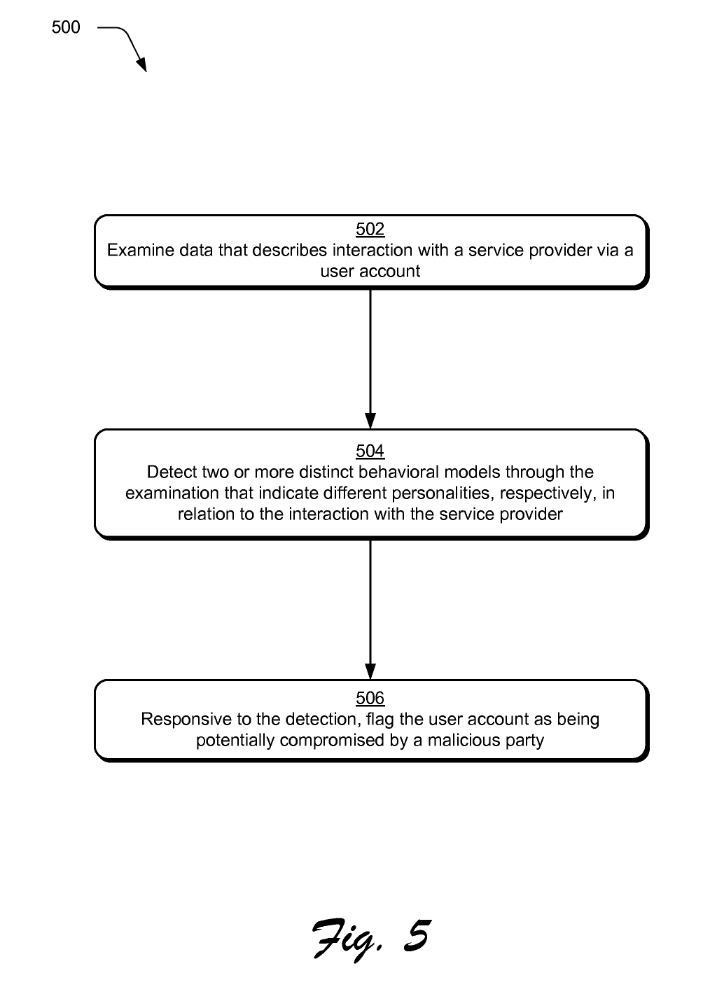

FIG. 5 is a flow diagram depicting a procedure in an example implementation in which detection of different personalities having distinct behaviors is employed to detect compromise of a user account. Data is examined that describes interaction with a service provider via a user account (block 502). As previously described, this data may originate from a variety of different sources, such as the service provider 102, through monitoring at the client device 104, and so on.

Two are more distinct behavior models are detected through the examination that indicate different personalities, respectively, in relation to the interaction with the service provider (block 504). For example, the previous techniques may be leveraged to detect different behaviors, such as interaction with different types of content through logins at different times, different collections of interactions that are performed with a same service, and so on. In this way the behavior module 114 may detect that the account has already been compromised. Again, a score and threshold may be employed that relate to a confidence level of this determination. Responsive to the detection, the user account is flagged as being potentially compromised by a malicious party (block 506), examples of which were previously described.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by one or more modules at least partially in hardware, the method comprising:
determining whether interaction with a service provider via a user account deviates from a model, the model based on behavior that was previously observed as corresponding to the user account; and
responsive to the determining that the interaction deviates from the model, flagging the user account as potentially compromised by a malicious party.

2. A method as described in claim 1, wherein the determined interaction involves communications and a number of the communications that are to be sent via the user account are within a permissible threshold.

3. A method as described in claim 1, wherein the determining is performed without receiving feedback from an intended recipient of communications from the user account.

4. A method as described in claim 1, wherein the model describes a sequence of actions that are typically performed using the user account.

5. A method as described in claim 1, wherein the model describes intended recipients of communications that are composed via the user account.

6. A method as described in claim 1, wherein the model describes a format of communications that are composed via the user account.

7. A method as described in claim 1, wherein the model describes an amount of data stored in conjunction with the user account.

8. A method as described in claim 1, wherein the model describes a number of items of data stored in conjunction with the user account.

9. A method as described in claim 1, wherein the model describes login characteristics of the user account.

10. A method as described in claim 1, wherein the model describes interaction performed via a social network.

11. A method as described in claim 1, wherein the model describes online storage of data in conjunction with the user account.

12. A method as described in claim 1, wherein the model describes customization of the user account.

13. A method as described in claim 1, further comprising generating the model using statistics that describe the behavior.

14. A method as described in claim 1, further comprising performing one or more actions to restrict the compromise to the user account.

15. A method implemented by one or more modules at least partially in hardware, the method comprising:
generating a model that describes behaviors exhibited through interaction via a user account of a service provider, the interaction performed over a network, wherein the behaviors are chosen from a plurality of behaviors that are consistent for the user but are not consistent for other users of the service provider; and
responsive to a determination that subsequent interaction performed via the user account deviates from the generated model, flagging the user account as potentially compromised by a malicious party.

16. A method as described in claim 15, further comprising performing one or more actions to restrict the compromise to the user account responsive to the flagging.

17. A method as described in claim 16, wherein the one or more actions include restricting the subsequent interaction that deviates from the generated model and permitting the subsequent interaction that is consistent with the model.

18. A method implemented by one or more modules at least partially in hardware, the method comprising:
examining data that describes interaction with a service provider via a user account;
detecting two or more distinct behavioral models through the examination that indicate different personalities, respectively, in relation to the interaction with the service provider; and
responsive to the detecting, flagging the user account as being potentially compromised by a malicious party.

19. A method as described in claim 18, further comprising performing one or more actions to restrict the compromise to the user account responsive to the flagging, wherein the one or more actions include restricting subsequent interaction that corresponds to a first said personality and permitting subsequent interaction that corresponds to a second said personality.

20. A method as described in claim 19, wherein the first said personality is identified as being potentially malicious.
